(19) United States
(12) Patent Application Publication
(10) Pub. No.: US 2018/0163664 A1
(43) Pub. Date: Jun. 14, 2018

(54) CONCENTRIC SHAFTS DRIVING ADJACENT FANS FOR AIRCRAFT PROPULSION

(71) Applicant: UNITED TECHNOLOGIES CORPORATION, Farmington, CT (US)

(72) Inventors: Gabriel L. Suciu, Glastonbury, CT (US); Jesse M. Chandler, South Windsor, CT (US)

(21) Appl. No.: 15/373,101

(22) Filed: Dec. 8, 2016

(51) Int. Cl. F02K 3/062

(52) U.S. Cl. CPC F02K 3/062

(57) ABSTRACT

A propulsion system for an aircraft has at least two fans, each fan having a fan drive shaft. A turboshaft gas turbine engine drives each of the at least two fans, and drive an output shaft which drives a gear to, in turn, engage for driving a gear on a first intermediate shaft extending from the turboshaft gas turbine engine in a rearward direction toward an intermediate fan drive shaft. The intermediate fan drive shaft drives ng the fan drive shaft, and the first intermediate shafts extending over a distance that is greater in an axial dimension defined between the turboshaft gas turbine engine and the fan than in a width dimension defined between the at least two fans. The first intermediate shafts are concentric.

### STATEMENT REGARDING FEDERALLY SPONSORED RESEARCH OR DEVELOPMENT

This invention was made with government support under Contract No. NND15AC56C, awarded by NASA. The Government has certain rights in this invention.

### BACKGROUND OF THE INVENTION

This application relates to the provision of a twin fan propulsion system for aircraft application.

Gas turbine engines are known for providing propulsion to aircraft. Typically, a fan delivers air into a bypass duct as propulsion air. The fan also delivers air into a compressor where it is compressed and then delivered into a combustor. In the combustor, the compressed air is mixed with fuel and ignited. Products of this combustion pass downstream over a turbine section driving turbine rotors to rotate. The turbine rotors, in turn, drive the compressor and fan.

Recently, advanced aircraft applications have been proposed wherein fans are mounted separately from a gas generator core engine which provides drive to the fans. The fans may be made relatively large and provide a good deal of additional propulsion, as they are not the source of air being delivered into the compressor.

However, drive systems for such remotely mounted fans have not been fully developed.

### SUMMARY OF THE INVENTION

In a featured embodiment, a propulsion system for an aircraft has at least two fans, each fan having a fan drive shaft. A turboshaft gas turbine engine drives each of the at least two fans, and drive an output shaft which drives a gear to, in turn, engage for driving a gear on a first intermediate shaft extending from the turboshaft gas turbine engine in a rearward direction toward an intermediate fan drive shaft. The intermediate fan drive shaft drives ng the fan drive shaft, and the first intermediate shafts extending over a distance that is greater in an axial dimension defined between the turboshaft gas turbine engine and the fan than in a width dimension defined between the at least two fans. The first intermediate shafts are concentric.

In another embodiment according to the previous embodiment, the intermediate fan drive shaft extends for a greater distance in the width dimension than in the axial direction and the fan drive shaft extending for a greater distance in the axial direction than in the width direction.

In another embodiment according to any of the previous embodiments, the first intermediate shafts and the fan drive shafts extend parallel to an axis of rotation of the at least two fans.

In another embodiment according to any of the previous embodiments, the intermediate fan drive shaft extends perpendicularly to the axis of rotation of the at least two fans.

In another embodiment according to any of the previous embodiments, a central axis of each the turboshaft gas turbine engine is parallel to the axis of rotation of the at least two fans.

In another embodiment according to any of the previous embodiments, the first intermediate shafts each extend to an output gear which engages a gear on the intermediate fan drive shaft, with the output gear on one of the first intermediate drive shafts extending to a position spaced rearwardly relative to one of the output gears on a second of the first intermediate shafts.

In another embodiment according to any of the previous embodiments, a central axis of each the turboshaft gas turbine engines is non-parallel to the axis of rotation of the at least two fans.

In another embodiment according to any of the previous embodiments, bevel gears drive the first intermediate shafts from the turboshaft gas turbine engines.

In another embodiment according to any of the previous embodiments, the first intermediate shafts each extend to an output gear which engages a gear on the intermediate fan drive shaft, with the output gear on one of the first intermediate drive shafts extending to a position spaced rearwardly relative to one of the output gears on a second of the first intermediate shafts.

In another embodiment according to any of the previous embodiments, the first intermediate shafts and the fan drive shafts extend parallel to an axis of rotation of the at least two fans.

In another embodiment according to any of the previous embodiments, the intermediate fan drive shaft extends perpendicularly to the axis of rotation of the at least two fans.

In another embodiment according to any of the previous embodiments, a central axis of each the turboshaft gas turbine engine is parallel to the axis of rotation of the at least two fans.

In another embodiment according to any of the previous embodiments, the first intermediate shafts each extend to an output gear which engages a gear on the intermediate fan drive shaft, with the output gear on one of the first intermediate drive shafts extending to a position spaced rearwardly relative to one of the output gears on a second of the first intermediate shafts.

In another embodiment according to any of the previous embodiments, a central axis of each the turboshaft gas turbine engines is non-parallel to the axis of rotation of the at least two fans.

In another embodiment according to any of the previous embodiments, bevel gears drive the first intermediate shafts from the turboshaft gas turbine engines.

In another embodiment according to any of the previous embodiments, the first intermediate shafts each extend to an output gear which engages a gear on the intermediate fan drive shaft, with the output gear on one of the first intermediate drive shafts extending to a position spaced rearwardly relative to one of the output gears on a second of the first intermediate shafts.

In another embodiment according to any of the previous embodiments, a central axis of each the turboshaft gas turbine engine is parallel to the axis of rotation of the at least two fans.

In another embodiment according to any of the previous embodiments, a central axis of each the turboshaft gas turbine engines is non-parallel to the axis of rotation of the at least two fans.

In another embodiment according to any of the previous embodiments, bevel gears drive the first intermediate shafts from the turboshaft gas turbine engines.

In another embodiment according to any of the previous embodiments, the first intermediate shafts each extend to an output gear which engages a gear on the intermediate fan drive shaft, with the output gear on one of the first intermediate drive shafts extending to a position spaced rearwardly relative to one of the output gears on a second of the first intermediate shafts.

These and other features may be best understood from the following drawings and specification.

### BRIEF DESCRIPTION OF THE DRAWINGS

FIG. 1 schematically shows an aircraft propulsion system.

FIG. 2 shows a feature.

FIG. 3 shows another feature.

FIG. 4 shows another feature.

### DETAILED DESCRIPTION

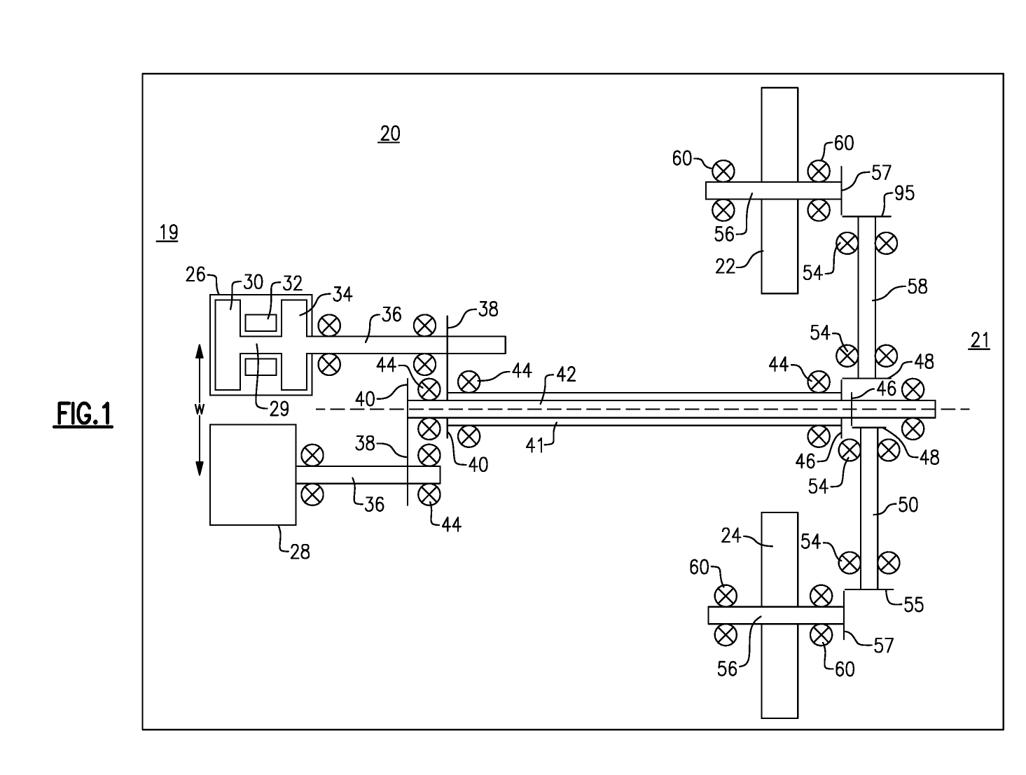

An aircraft 20 is shown having a forward location 19 and a rearward location 21. All of the structure illustrated in FIG. 1 may be generally found in the tail portion of the aircraft, however, numbers 19 and 21 give perspective for the relative direction. In addition, a width W is illustrated across the aircraft 20.

Two large fans 22 and 24 are shown and provide propulsion for the aircraft 20. The fan 22 is driven by a turboshaft engine 26 and the fan 24 is powered by a turboshaft engine 28. Each engine 26 and 28 includes a compressor section 30, a combustor 32, and a turbine section 34. The turbine section 34 drives a shaft 29 to, in turn, drive the compressor 30. The turbine section 34 also drives a shaft 36 which drives a gear 38. Gears 38 engage gears 40 each driving separate shafts 41 and 42, which are mounted in bearings 44.

Shafts 41 and 42 drive a gear 46 which engages a gear 48. Each gear 48 drives shafts 50, which are mounted in bearings 54. The shafts 50, in turn, drive gears 55. Gears 55 drive shafts 56 through gears 57. Shafts 56, in turn, drive fan rotors in both fans 22 and 24. In addition, shafts 56 are mount in bearings 60.

As can be appreciated, the shafts 41 and 42 extends from the engines 26 and 28 generally along an axial direction between locations 19 and 21. As shown in this Figure, the shafts 36 and 42 extend generally parallel to a forward direction along the aircraft or parallel to an axis of rotation of fans 22/24. The shafts 50 are perpendicular to the shafts 42 and the shafts 56 are parallel to the shafts 42. The fan rotor rotates on an axis of rotation of shafts 56.

One could say the system includes at least two first intermediate drive shafts extend over a distance that is greater in an axial dimension, defined between the turboshaft 41/42, gas turbine engine 26/28, and the fan 22/24, than it is in a width dimension defined between the at least two fans 22/24.

More generally, it could be said the shafts 36, 41 and 42 extend along the axial dimension for a greater distance than they do along the width dimension. The same is true for the shafts 56. On the other hand, the shafts 50 could be said to extend along a greater distance in the width dimension than they do in the axial dimension.

As can be appreciated from FIG. 1, the shafts 36 extend from the turbine and in a rearward direction.

As can be appreciated from FIG. 1, shaft 41 is hollow and shaft 42 extends through the hollow shaft 41. The shafts are mounted concentrically, which requires less width for packaging purposes. This arrangement is particularly advantageous when tight packing constraints exist.

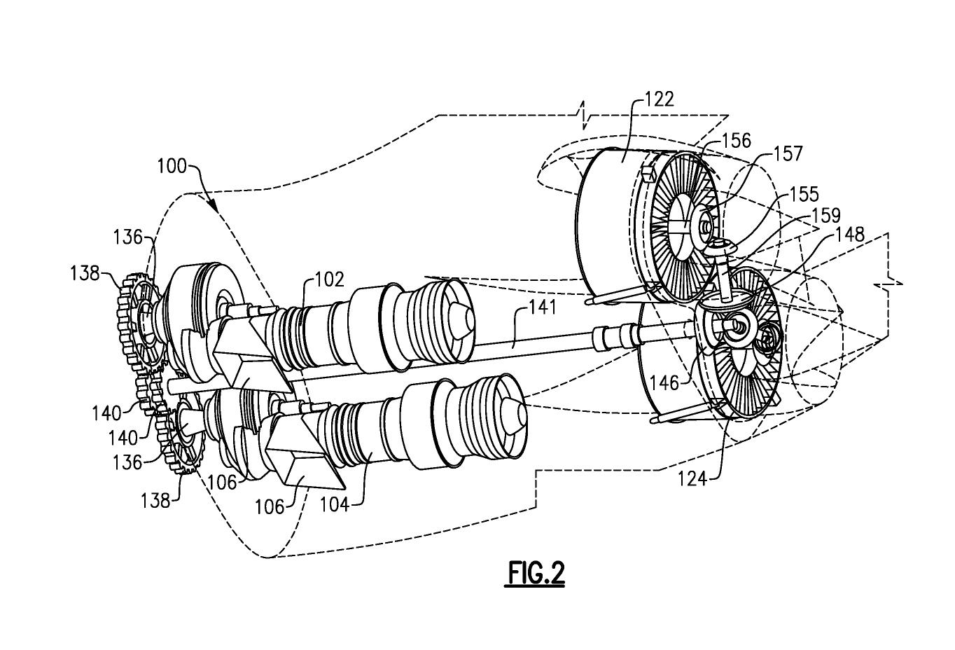

FIG. 2 shows an embodiment 100 which is generally similar to the embodiment of FIG. 1, however the drive shafts 136 can now be seen to extend from the forward end of the engine, or beyond the compressor section. Scoop air inlets 106 are also shown, which would preferably also be true for the engines 26 and 28 of FIG. 1. Air is provided to the compressor through the inlet 106. The other features are generally the same as in the FIG. 1 embodiment, however, their numerals are increased by 100.

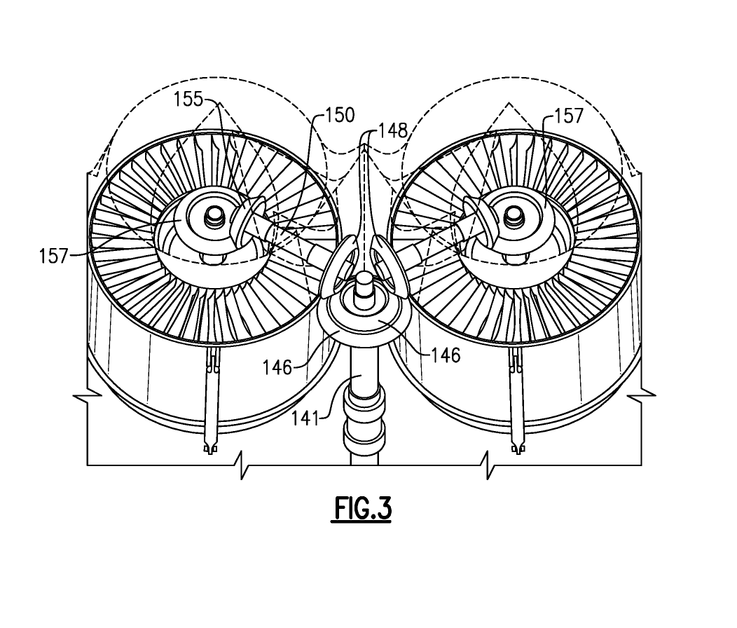

FIG. 3 shows further details. As can be seen, the gear 146 driven by the inner intermediate shaft 142 extends slightly rearwardly of the gear 146 driven by the outer shaft 141. The gears engage gears 148 to in turn drive their respective intermediate fan drive shaft 150. Gears 155 driven by the intermediate fan drive shaft in turn drive the gears 157.

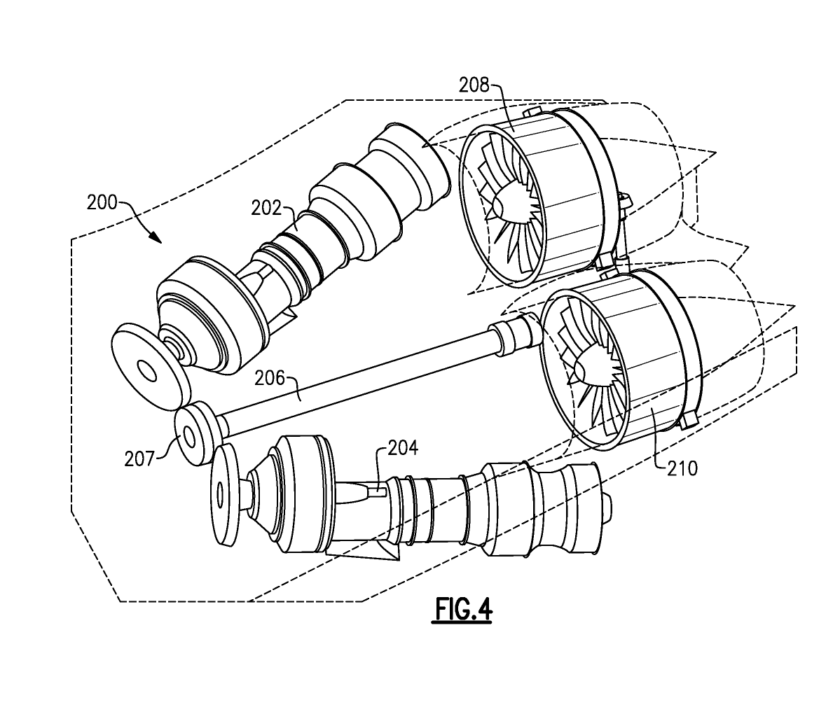

FIG. 4 shows an embodiment 200, wherein the engines 202 and 204 are at an angle relative to the fan rotational axis. The shafts 206 and 207 are still parallel to an axis of the fans, also now at an angle and drive the fans 208 and 210 through intermediate shafts.

By angling the engines, better packaging may be achieved for a particular aircraft application. Bevel gears may be utilized between engines 202 and 204, and shafts 206 and 207.

Although an embodiment of this invention has been disclosed, a worker of ordinary skill in this art would recognize that certain modifications would come within the scope of this invention. For that reason, the following claims should be studied to determine the true scope and content of this invention.

1. A propulsion system for an aircraft comprising:
at least two fans, each said fan having a fan drive shaft;
a turboshaft gas turbine engine for driving each of said at least two fans, said turboshaft engines driving an output shaft which drives a gear to, in turn, engage for driving a gear on a first intermediate shaft extending from said turboshaft gas turbine engine in a rearward direction toward an intermediate fan drive shaft, said intermediate fan drive shaft driving said fan drive shaft, and said first intermediate shafts extending over a distance that is greater in an axial dimension defined between said turboshaft gas turbine engine and said fan than in a width dimension defined between said at least two fans; and
said first intermediate shafts being concentric.

2. The propulsion system as set forth in claim 1, wherein said intermediate fan drive shaft extends for a greater distance in the width dimension than in said axial direction and said fan drive shaft extending for a greater distance in said axial direction than in said width direction.

3. The propulsion system as set forth in claim 2, wherein said first intermediate shafts and said fan drive shafts extend parallel to an axis of rotation of said at least two fans.

4. The propulsion system as set forth in claim 3, wherein said intermediate fan drive shaft extends perpendicularly to said axis of rotation of said at least two fans.

5. The propulsion system as set forth in claim 4, wherein a central axis of each said turboshaft gas turbine engine is parallel to said axis of rotation of said at least two fans.

6. The propulsion system as set forth in claim 5, wherein said first intermediate shafts each extend to an output gear which engages a gear on said intermediate fan drive shaft, with said output gear on one of said first intermediate drive shafts extending to a position spaced rearwardly relative to one of said output gears on a second of said first intermediate shafts.

7. The propulsion system as set forth in claim 4, wherein a central axis of each said turboshaft gas turbine engines is non-parallel to said axis of rotation of said at least two fans.

8. The propulsion system as set forth in claim 7, wherein bevel gears drive said first intermediate shafts from said turboshaft gas turbine engines.

9. The propulsion system as set forth in claim 8, wherein said first intermediate shafts each extend to an output gear which engages a gear on said intermediate fan drive shaft, with said output gear on one of said first intermediate drive shafts extending to a position spaced rearwardly relative to one of said output gears on a second of said first intermediate shafts.

10. The propulsion system as set forth in claim 1, wherein said first intermediate shafts and said fan drive shafts extend parallel to an axis of rotation of said at least two fans.

11. The propulsion system as set forth in claim 10, wherein said intermediate fan drive shaft extends perpendicularly to said axis of rotation of said at least two fans.

12. The propulsion system as set forth in claim 11, wherein a central axis of each said turboshaft gas turbine engine is parallel to said axis of rotation of said at least two fans.

13. The propulsion system as set forth in claim 12, wherein said first intermediate shafts each extend to an output gear which engages a gear on said intermediate fan drive shaft, with said output gear on one of said first intermediate drive shafts extending to a position spaced rearwardly relative to one of said output gears on a second of said first intermediate shafts.

14. The propulsion system as set forth in claim 11, wherein a central axis of each said turboshaft gas turbine engines is non-parallel to said axis of rotation of said at least two fans.

15. The propulsion system as set forth in claim 14, wherein bevel gears drive said first intermediate shafts from said turboshaft gas turbine engines.

16. The propulsion system as set forth in claim 15, wherein said first intermediate shafts each extend to an output gear which engages a gear on said intermediate fan drive shaft, with said output gear on one of said first intermediate drive shafts extending to a position spaced rearwardly relative to one of said output gears on a second of said first intermediate shafts.

17. The propulsion system as set forth in claim 1, wherein a central axis of each said turboshaft gas turbine engine is parallel to said axis of rotation of said at least two fans.

18. The propulsion system as set forth in claim 1, wherein a central axis of each said turboshaft gas turbine engines is non-parallel to said axis of rotation of said at least two fans.

19. The propulsion system as set forth in claim 18, wherein bevel gears drive said first intermediate shafts from said turboshaft gas turbine engines.

20. The propulsion system as set forth in claim 1, wherein said first intermediate shafts each extend to an output gear which engages a gear on said intermediate fan drive shaft, with said output gear on one of said first intermediate drive shafts extending to a position spaced rearwardly relative to one of said output gears on a second of said first intermediate shafts.
